(19) United States
(12) Patent Application Publication
(10) Pub. No.: US 2017/0122004 A1
(43) Pub. Date: May 4, 2017

(54) ADJUSTABLE GATE LATCH BAR

(71) Applicant: Eric F. Calamia, III, Monte Sereno, CA (US)

(72) Inventor: Eric F. Calamia, III, Monte Sereno, CA (US)

(21) Appl. No.: 14/929,305

(22) Filed: Oct. 31, 2015

(51) Int. Cl. E05B 15/02; E05B 63/00; E05B 65/00; E05C 3/04

(52) U.S. Cl. CPC E05B 15/025; E05C 3/046; E05B 63/0056; E05B 65/0007

(57) ABSTRACT

An adjustable gate latch bar can include: (i) a base plate configured to be fixedly secured to a gate, where the base plate includes first and second elongated slots; (ii) a gate latch bar having first and second bar mounting holes that correspond to the first and second elongated slots; and (iii) first and second thumb screws configured to connect the gate latch bar to the base plate such that the gate latch bar is adjustable when at least one of the first and second thumb screws is loosened, and the gate latch bar is secured to the base plate when the first and second thumb screws are tightened.

### FIELD OF THE INVENTION

The present disclosure generally relates to the field of gate latches, and more particularly to an adjustable gate latch bar configured for a gate latch structure.

### BACKGROUND

Gate latches come in a variety of types and styles, and are commonly used on wooden gates on side yards of fenced-in property, or in similar applications. Generally, a gate latch may be used in order to keep the gate closed and secure. One of most common side yard gate latches is commonly referred to as a “gravity latch,” which automatically latches when the gate latch bar on the swinging gate strikes the gate latch “cam” as the gate closes. The gate latch cam can slide up on the gate latch bar, and then drop back down when the gate latch bar has reached the back of the opening in the gate latch. Once the gate latch cam has dropped back down, the gate latch bar is captured in the latch, and the gate is secure in a closed position. To open the gate, the gate latch cam may be manually pulled open, such as by a pull cable from the outside of the gate, or may be pushed open with a finger from inside the gate.

### SUMMARY

In one embodiment, an adjustable gate latch bar can include: (i) a base plate configured to be fixedly secured to a gate, where the base plate includes first and second elongated slots; (ii) a gate latch bar having first and second bar mounting holes that correspond to the first and second elongated slots; and (iii) first and second thumb screws configured to connect the gate latch bar to the base plate such that the gate latch bar is adjustable when at least one of the first and second thumb screws is loosened, and the gate latch bar is secured to the base plate when the first and second thumb screws are tightened.

### BRIEF DESCRIPTION OF THE DRAWINGS

FIG. 1 is a detail perspective view of an example adjustable gate latch bar in a misaligned configuration, in accordance with embodiments of the present invention.

FIG. 2 is a detail perspective view of an example adjustable gate latch bar in an aligned configuration, in accordance with embodiments of the present invention.

FIG. 3 is an exploded view of primary components of an example adjustable gate latch bar, in accordance with embodiments of the present invention.

FIG. 4 is a front perspective view of an example base plate component, in accordance with embodiments of the present invention.

FIG. 5 is a rear perspective view of an example base plate component, in accordance with embodiments of the present invention.

FIG. 6 is a bottom perspective view of an example thumb screw component, in accordance with embodiments of the present invention.

FIG. 7 is a top perspective view of an example sliding nut component, in accordance with embodiments of the present invention.

FIG. 8 is a section detail view of the example adjustable gate latch bar along line 8-8 of FIG. 1, in accordance with embodiments of the present invention.

FIG. 9 is a section detail view of the example adjustable gate latch bar along line 9-9 of FIG. 1, in accordance with embodiments of the present invention.

FIG. 10 is a section detail view of an example thumb screw loosened and translated horizontally, in accordance with embodiments of the present invention.

FIG. 11 is a section detail view of the example adjustable gate latch bar showing multiple components translated vertically to a secondary position, in accordance with embodiments of the present invention.

FIG. 12 is a section detail view of the example adjustable gate latch bar along line 12-12 of FIG. 1 with the thumb screw tightened and translated horizontally, in accordance with embodiments of the present invention.

### DETAILED DESCRIPTION

The present invention is described in one or more embodiments in the following description with reference to the figures, in which like numerals may represent the same or similar elements. While the invention is described in terms of the best mode for achieving the invention's objectives, it will be appreciated by those skilled in the art that it is intended to cover alternatives, modifications, and equivalents as may be included within the spirit and scope of the invention, as defined by the appended claims and their equivalents as supported by the following disclosure and drawings.

In many practical gate usage patterns, the gate may sag or the hinge post or latch post can warp or shift as a result of weather changes and the natural aging process. This can cause the gate latch and gate latch bar to become misaligned with respect to each other over time. When this occurs, the gate latch may not latch at all in some cases. In other cases, the gate may not close all the way, or it may be difficult to open the latch in order to open the gate. In particular embodiments, such misalignment in the gate latch can be corrected by use of the exemplified adjustable gate latch bar.

In one gate latch approach whereby the gate latch is provided along with a gate latch bar, the gate latch includes four holes for mounting to a gate post, and the gate latch bar has two holes for mounting to the gate. However, once the gate latch and gate latch bar have been mounted to the gate, neither of them is adjustable. Thus, when misalignment occurs in this particular approach, the only way to re-align the gate latch and gate latch bar is to drill new pilot holes in a new location, and then to move and re-mount the gate latch bar and/or the gate latch. This can lead to multiple sets of holes remaining on the post and/or gate after a period of time.

In another gate latch approach whereby the gate latch is provided with an adjustable self-aligning gate latch bar, the gate latch bar includes a pivot pin that fits in one of two available holes in the gate latch bar mounting plate. The gate latch bar can thus pivot up or down to accommodate for misalignment. However, if the alignment becomes severe and the motion of the latch bar is not enough to accommodate the misalignment, the latch bar plate can be removed and the latch bar pivot pin can be put in a second hole to reposition the latch bar closer to aligning with the gate latch. Then, the pivoting movement of the gate latch bar can again attempt to automatically align with the latch. However, the pivot point may be less than about 4″ from the latch, and as the latch bar moves up or down to self-align with the gate latch, the gate latch bar may now be at an angle with respect to the gate latch. Thus, the gate latch bar can rub/stick on the gate latch opening in this case, causing it to stick and bind when closing and opening the gate.

In another approach whereby an automatic latch is provided with an adjustable gate latch bar, the gate latch bar is integrated into a mounting base that has elongated slots in it. The latch bar may be mounted to the gate with two screws going through the elongated slots in the mounting base, which can allow the screws to be loosened and the gate latch bar to be slid up/down to align with the gate latch. However, the adjustable screws in this case are threaded into wood, and as a result they can't be repeatedly loosened and tightened without the screws becoming loose or stripped. Screws in wood generally cannot be tightened enough to prevent the screws from sliding out of alignment without stripping, and they can't be repeatedly tightened and loosened without the holes in the wood enlarging and stripping. Another problem can occur when trying to mount such a latch bar on the edge of, e.g., a 1½″ thick piece of 2×4 would because the mounting base and the elongated slots can exceed the 1½″ width of a 2×4 of wood.

In particular embodiments, an adjustable gate latch bar can include a base plate, a latch bar, two thumb screws, and two (e.g., rectangular) sliding nuts. One or more of the components in the adjustable gate latch bar structure as described herein can be made of metal for durability; however, other materials can alternatively or additionally be utilised in certain embodiments. The base plate can mount to a gate with base plate fasteners (e.g., two flat head screws). Also, the base plate may have two elongated slots therein in order to allow for a wide range of adjustability of the gate latch bar. The gate latch bar can be positioned or repositioned anywhere along the length of the elongated slots, and may then be secured in the desired position by tightening the two thumb screws.

Also in particular embodiments, the two thumb screws can thread into the two rectangular sliding nuts configured in a cavity on the backside of the base plate. The shape of the rectangular sliding nuts may prevent them from turning because one of the flat surfaces or a corner of the sliding nut can make contact with the side of the base plate cavity wall when the thumb screw is turned (e.g., tightened). Also, threads on the end of each of the thumbs screws can extend beyond the thickness of the rectangular nuts, and may be “swaged” such that the thumb screws may not accidently be unthreaded and backed out of the sliding rectangular nuts. In this fashion, adjustability of the adjustable gate latch bar can be accommodated without the use of tools, and the gate latch bar and the gate latch can be maintained in alignment such that the gate latch easily opens, closes, and securely latches.

Certain embodiments can provide an adjustable gate latch bar within a specific or predetermined adjustment range, and that can be easily and repeatedly adjusted to align with the gate latch. The gate latch bar can be slid up or down according to elongated slots in a base plate that is fixedly attached to the gate independently of the gate latch bar. The adjustable gate latch bar may incorporate thumb screws to hold the gate latch bar in the desired location on the metal base plate. Also, the thumb screws can be loosened and tightened without using tools, and the thumb screws may be thread into sliding nuts to accommodate repeated loosening and tightening.

In one embodiment, an adjustable gate latch bar can include: (i) a base plate configured to be fixedly secured to a gate, where the base plate includes first and second elongated slots; (ii) a gate latch bar having first and second bar mounting holes that correspond to the first and second elongated slots; and (iii) first and second thumb screws configured to connect the gate latch bar to the base plate such that the gate latch bar is adjustable when at least one of the first and second thumb screws is loosened, and the gate latch bar is secured to the base plate when the first and second thumb screws are tightened.

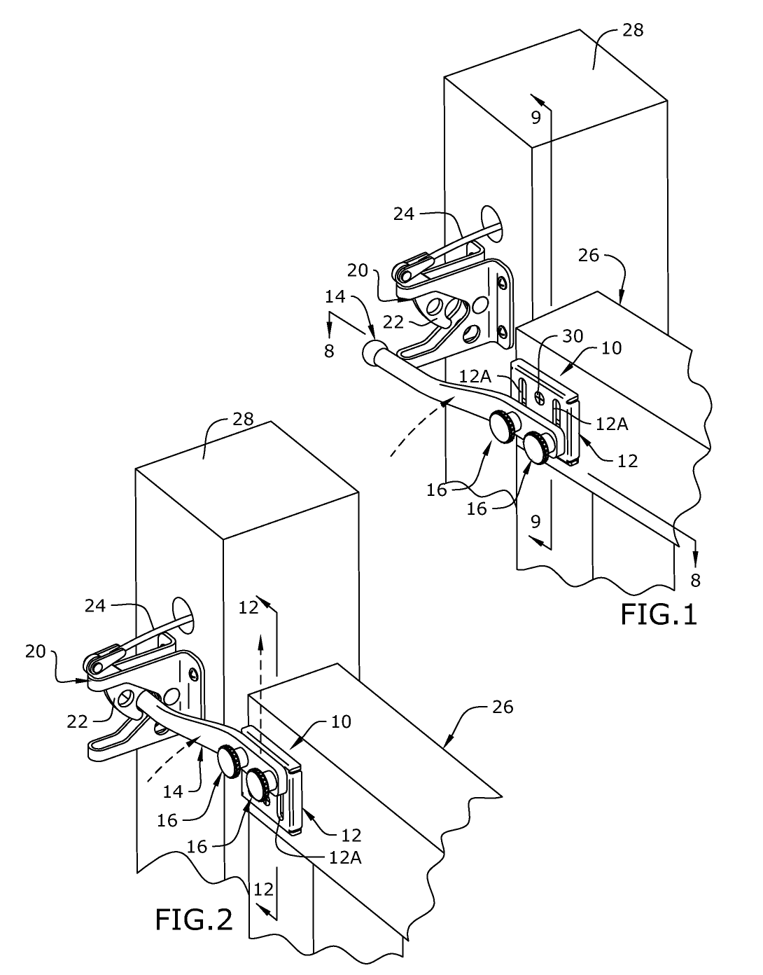

Referring now to FIG. 1, shown is a detail perspective view of an example adjustable gate latch bar in a misaligned configuration, in accordance with embodiments of the present invention. In this particular example, gate latch bar 14 on gate 26 can be misaligned with respect to gate latch 20 on gate post 28. Gate latch bar 14 can be held to base plate 12 with two thumb screws 16. For example, each of base plate 12, gate latch bar 14, and thumb screws 16, as well as other components herein, can be made of metal (e.g., aluminum, etc.), or any other suitable material (e.g., molded plastic, etc.).

Adjustable gate latch bar 10 can include base plate 12, gate latch bar 14, and thumb screws 16. Base plate 12 can be fixedly secured to gate 26 by base plate fasteners (e.g., flat head screws) 30. Base plate 12 can include base plate elongated slots 12A that allow for adjustment of gate latch bar 14 with flexibility in terms of the adjustment angle (e.g., the gate latch bar pointing upwards, downwards, level, etc.). Gate latch 20 can include gate latch cam 22 and pull cable 24, and may be fixedly attached to gate post 28 by way of screws. In the misaligned configuration example shown in FIG. 1, gate latch bar 14 is too low, such as from a sagging of gate 26 over time, with respect to gate latch 20, and in particular is misaligned with respect to gate latch cam 22 for proper opening and closing of gate 26.

Referring now to FIG. 2, shown is a detail perspective view of an example adjustable gate latch bar in an aligned configuration, in accordance with embodiments of the present invention. In this example, gate latch bar 14 has been realigned with gate latch 20 such that gate latch cam 22 properly latches to secure gate latch bar 14, and also releases gate latch bar 14 in order to allow gate 26 to easily open. Thus, gate latch bar 14 can be aligned and re-aligned (e.g., after becoming misaligned due to weather, aging, etc.) with gate latch 20 through the use of stationary base plate 12 with base plate elongated slots 12A. Base plate 12 can be fixedly attached to gate 26 by way of base plate fasteners (e.g., flat head screws) 30 that extend into gate 26. In order to perform realignment of gate latch bar 14 with respect to gate latch 20, thumb screws 16 can be loosened (e.g., by turning counterclockwise), gate latch bar 14 can then be moved to the desired location, and then thumb screws 16 may be tightened (e.g., by turning clockwise).

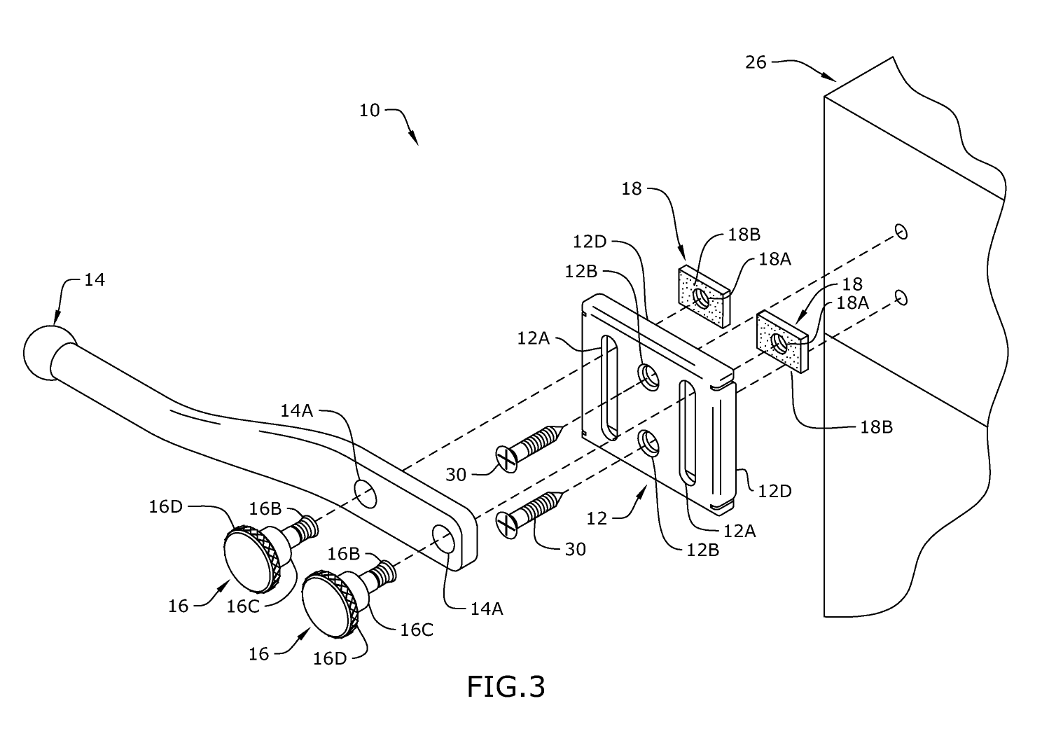

Referring now to FIG. 3, shown is an exploded view of primary components of an example adjustable gate latch bar, in accordance with embodiments of the present invention. Example adjustable gate latch bar 10 can include thumb screws 16 that may thread into female threads 18A in sliding nuts 18 that reside in a cavity on the backside of base plate 12. Each thumb screw 16 can include swaged end 16B, thumb screw shoulder 16C, and thumb screw knurled head 16D. Any suitable surface (e.g., upset, textured, coated, knurled, etc.) of thumb screw head 16D in order to facilitate gripping (e.g., by fingers) thereof can be supported in particular embodiments.

Gate latch bar 14 can include mounting holes 14A to allow for thumb screws 16 to connect with sliding nuts 18 to appropriately align gate latch bar 14 with respect to gate latch 20. The thumb screw threads can pass through gate latch bar mounting holes 14A and base plate elongated slots 12A, and may thread into corresponding sliding nut female threads 18A that are located in the base plate cavity of base plate 12. Thumb screws 16 may be prevented from backing out of sliding nuts 18 by thumb screw swaged ends 16B on the thumb screw threads. Also, base plate fasteners 30 can go through base plate mounting holes 12B, and may thread into gate 26 in order to fixedly attach/secure base plate 12 to gate 26.

Thumb screws 16 can be utilized to control repositioning, and to secure a new fixed position of gate latch bar 14 on base plate 12. Thumb screws 16 can be loosened by gripping thumb screw knurled head 16D and turning (e.g., counterclockwise) one or both of thumb screws 16 until gate latch bar 14 is movable. Thumb screw swaged ends 16B help to prevent from loosening thumb screws 16 too much such that the attachment with sliding nuts 18 is lost. Thumb screws 16 can be tightened by gripping thumb screw knurled head 16D and turning (e.g., clockwise) thumb screw 16 until thumb screw shoulder 16C presses against gate latch bar 14 and squeezes base plate 12 in-between gate latch bar 14 and sliding nut textured/hardened surface 18B. Also, gate latch bar 14 may be a standard gate latch bar that is available from several gate hardware manufacturers.

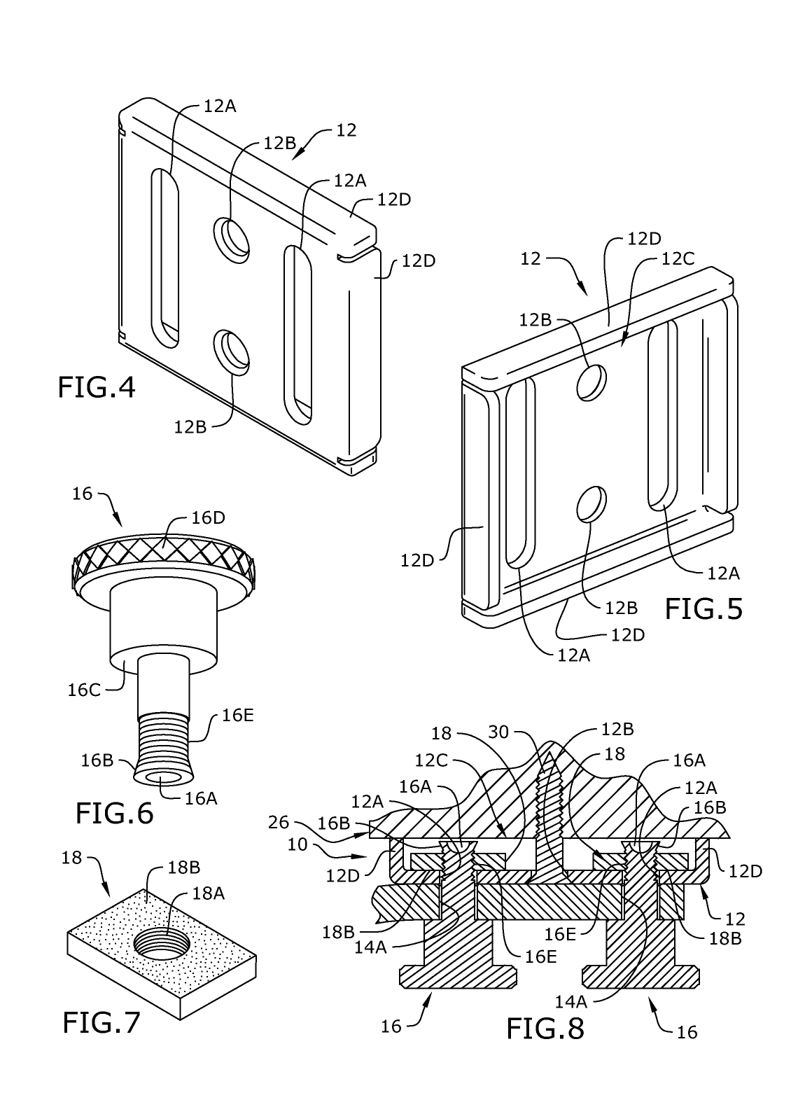

Referring now to FIG. 4, shown is a front perspective view of an example base plate component, in accordance with embodiments of the present invention. Base plate 12 can include elongated slots 12A, mounting holes 12B, and base plate folds/standoffs 12D. For example, base plate 12 can be a stamped or folded sheet metal product. Also, elongated slots 12A can define the range of possible angles, including upward, downward, and level angles, of gate latch bar 14 as adjustably attached to base plate 12. For example, elongated slots 12A can be a little over an inch (e.g., about 1 and ⅛ inches) in some cases; however, any suitable elongated slots lengths (e.g., 0.5 inches, 1.5 inches, 2 inches, etc.) can be supported in particular embodiments.

Referring now to FIG. 5, shown is a rear perspective view of an example base plate component, in accordance with embodiments of the present invention. In this view, base plate cavity 12C is shown. Base plate cavity 12C can house sliding nuts 18 for connection to thumb screws 16 in order to secure gate latch bar 14. In addition, base plate folds/standoffs 16D can form cavity walls that are sufficiently high in order to house sliding nuts 18. For example, cavity walls 16D can be about 3/16 of an inch high in some cases; however, any suitable base plate fold or wall 16D height can be accommodated in certain embodiments. In particular, this cavity wall 16D height may allow sufficient room for sliding nuts 18 and thumb screws 16 to move together for adjustment positioning along elongated slots 12A while base plate 12 is fixedly secured to gate 26.

Referring now to FIG. 6, shown is a bottom perspective view of an example thumb screw component, in accordance with embodiments of the present invention. Thumb screw 16 can include thumb screw cup 16A, thumb screw swaged end 16B, thumb screw shoulder 16C, thumb screw knurled head 16D, and thumb screw threads 16E. For example, thumb screw swaged end 16B can be created by deforming thumb screw cup 16A. Also for example, thumb screws 16 can be made on a lathe or screw machine, and any suitable size (e.g., a radius of about ⅝ inch of thumb screw knurled head 16D) can be supported in certain embodiments.

In addition, there may be a smooth (e.g., unthreaded) portion of thumb screws 16 between thumb screw shoulders 16C and threads 16E. This smooth portion can be slightly less than or substantially as thick as gate latch bar 14 at mounting holes 14A, and may substantially extend through mounting holes 14A. Thumb screw 16 may extend beyond a corresponding sliding nut 18 while attached thereto. Accordingly, base plate folds/standoffs 12D shown above in FIG. 5 may have a height that is greater than the thickness of sliding nuts 18 plus the portions of thumb screw 16 (e.g., cup 16A, swaged end 16B, and some of threads 16E) that extend beyond sliding nuts 18.

Referring now to FIG. 7, shown is a top perspective view of an example sliding nut component, in accordance with embodiments of the present invention. Sliding nut 18 can include female threads 18A and textured/hardened surface 18B. Female threads 18A can be utilized to match with thumb screw threads 16E to secure gate latch bar 14 to base plate 12. Sliding nut textured/hardened surface 18B can contact with the back surface or cavity 12C of base plate 12. Thus, sliding nut textured/hardened surface 18B can help to keep sliding nuts 18 from sliding too easily, and to facilitate securing sliding nuts 18 (on a back surface/cavity 12C) to base plate 12 via thumb screws 16 (via a front surface and elongated slots 12A).

For example, sliding nuts 18 can be stamped out of sheet metal and then drilled, threaded, textured, and hardened. In addition, while rectangular shaped sliding nuts 18 are shown in the examples herein, any suitable shape (e.g., square, octagonal, etc.) of sliding nut 18 that may not fully rotate when thumb screws 16 are tightened can be utilized in particular embodiments. For example, any shape/size of sliding nuts 18 can be accommodated, and a suitable shape/size can be one that makes contact (e.g., via a corner or side the sliding nut) with a base plate fold/standoff 12D upon the tightening of a corresponding thumb screw 16 such that the sliding nut does not fully rotate within base plate cavity 12C. Thus, the shape/size of sliding nuts 18 can facilitate the securing of gate latch bar 14 via thumb screws 16 and sliding nuts 18 without requiring any tools by holding sliding nut 18 substantially in place while the corresponding thumb screw 16 is tightened.

In the examples herein, thumb screws and sliding nuts are shown and described as fastening structures. However, certain embodiments may also support alternative types of fasteners, such as any suitable screw and nut combinations (e.g., Phillips round head, sliding carriage bolts, standard nuts, female threaded thumb screws, etc.), such that gate latch bar 14 can be easily repositioned and secured to base plate 12.

Referring now to FIG. 8, shown is a section detail view of the example adjustable gate latch bar along line 8-8 of FIG. 1, in accordance with embodiments of the present invention. This view cuts through adjustable gate latch bar structure 10 looking downward, and shows base plate 12 secured to gate 26 via base plate fasteners/screws 30. Also, thumb screws 16 are shown to secure latch bar 14 to base plate 12 through mounting holes 14A and elongated slots 12A. It can be seen that base plate folds/standoffs or cavity walls 12D make contact with gate 26, and also have a height sufficient to allow for an end (e.g., thumb screw cups 16A and swaged ends 16B) of thumb screws 16 to have clearance with respect to gate 26 to allow for movement during gate latch bar adjustment.

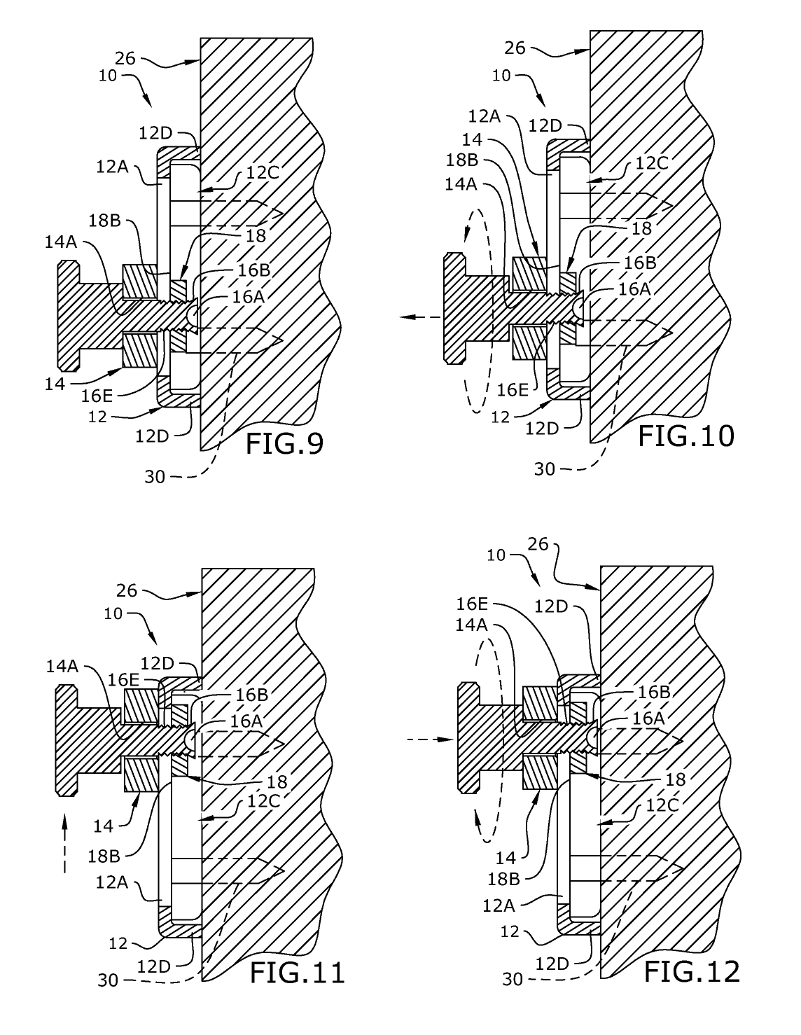

Referring now to FIG. 9, shown is a section detail view of the example adjustable gate latch bar along line 9-9 of FIG. 1, in accordance with embodiments of the present invention. This view cuts through adjustable gate latch bar structure 10 in a vertical direction, and also shows base plate 12 secured to gate 26 via base plate fasteners 30. Also shown are base plate folds/standoffs 12D making contact with gate 26 as a result of base plate fasteners 30. It can be seen that when in a tightened position, thumb screw shoulders 16C are firmly pressed against gate latch bar 14, and gate latch bar 14 is firmly pressed against base plate 12.

Referring now to FIG. 10, shown is a section detail view of an example thumb screw loosened and translated horizontally, in accordance with embodiments of the present invention. This case shows thumb screw 16 being loosened by turning the thumb screw (or both thumb screws) in a counterclockwise direction. Thus, once gate latch bar 14 is sufficiently loosened, it can be repositioned for alignment with gate latch 20. It can be seen that when in a loosened state, thumb screw shoulders 16C may have a slight gap respect to gate latch bar 14. The thumb screw and sliding nut arrangement can remain intact (e.g., in connection with each other) while in this loosened state. As discussed above, the range of repositioning of a given thumb screw 16 and sliding nut 18 arrangement can extend a length of the corresponding elongated slot 12A.

Referring now to FIG. 11, shown is a section detail view of the example adjustable gate latch bar showing multiple components translated vertically to a secondary position, in accordance with embodiments of the present invention. In this example, gate latch bar 14 can be translated vertically or moved up, such as for better or optimized alignment with gate latch 20. Here, the new position of the thumb screw 16 and sliding nut 18 arrangement is near a top of the corresponding elongated slots 12A. Further, in some cases, only one of the two thumb screws may be loosened at a time, while in other cases both thumb screws 16 can be loosened. In any event, both of thumb screws 16 can be tightened, or may remain in a tightened state, in order to secure the position of gate latch bar 14.

Referring now to FIG. 12, shown is a section detail view of the example adjustable gate latch bar along line 12-12 of FIG. 1 with the thumb screw tightened and translated horizontally, in accordance with embodiments of the present invention. Once the desired position of gate latch bar 14 is obtained, thumb screw(s) 16 can be retightened by turning the thumb screw in a clockwise direction as shown, or may otherwise remain in a tightened state. In this way, gate latch bar 14 can be repositioned into a desired location within a range as provided by the combination of elongated slots 12A.

An adjustable gate latch bar of particular embodiments can be relatively easy and inexpensive to manufacture, and may not require extensive tooling for such manufacture. For example, an existing and commonly manufactured gate latch bar (e.g., 14) can be utilized in certain embodiments. Also, the base plate (e.g., 12) can be formed from relatively inexpensive sheet metal. In addition, thumb screws (e.g., 16) as described herein can allow for adjustment of the gate latch bar anytime, and without having to use any tools (e.g., wrenches, screwdrivers, etc.). Further, particular embodiments may utilize rectangular sliding nuts (e.g., 18) that may not fully rotate when the thumb screws are loosened or tightened.

Particular embodiments incorporate the use of a stationary intermediate base plate (e.g., 12) to isolate wooden gates (e.g., 26) from gate hardware adjustment components. Also, elongated slots (e.g., 12A) can be utilized to accommodate a wide range of positional adjustments, including both height and angle (e.g., upwards/downwards) adjustments of the gate latch bar. In this way, common gate latch problems of binding, difficulty in opening, difficulty enclosing, non-latching, and misaligned gate latches can be addressed and substantially overcome.

The embodiments were chosen and described in order to best explain the principles of the invention and its practical applications, to thereby enable others skilled in the art to best utilise the invention and various embodiments with modifications as are suited to particular use(s) contemplated. It is intended that the scope of the invention be defined by the claims appended hereto and their equivalents.

What is claimed is:

1. An adjustable gate latch bar, comprising:
a) a base plate configured to be fixedly secured to a gate, wherein the base plate comprises first and second elongated slots;
b) a gate latch bar having first and second bar mounting holes that correspond to the first and second elongated slots; and
c) first and second thumb screws configured to connect the gate latch bar to the base plate such that the gate latch bar is adjustable when at least one of the first and second thumb screws is loosened, and the gate latch bar is secured to the base plate when the first and second thumb screws are tightened.

2. The adjustable gate latch bar of claim 1, further comprising first and second sliding nuts having threads configured to connect to threads of the first and second thumb screws through the first and second elongated slots.

3. The adjustable gate latch bar of claim 2, wherein each of the first and second sliding nuts comprises a rectangular shape,

4. The adjustable gate latch bar of claim 2, wherein each of the first and second sliding nuts comprises a textured surface that makes contact with a back surface of the base plate,

5. The adjustable gate latch bar of claim 2, wherein the base plate comprises folds at each of four sides thereof such that a base plate cavity is formed.

6. The adjustable gate latch bar of claim 5, wherein the base plate cavity faces the gate when the base plate is fixedly secured to the gate.

7. The adjustable gate latch bar of claim 5, wherein the first and second sliding nuts reside in the base plate cavity.

8. The adjustable gate latch bar of claim 7, wherein at least a corner of at least one of the first and second sliding nuts is configured to make contact with one of the folds when a corresponding of the first and second thumb screws is tightened.

9. The adjustable gate latch bar of claim 7, wherein the base plate cavity is configured to allow the first and second sliding nuts to move freely along the first and second elongated slots without making contact with a surface of the gate.

10. The adjustable gate latch bar of claim 1, wherein the base plate comprises first and second base plate mounting holes.

11. The adjustable gate latch bar of claim 10, further comprising first and second base plate fasteners configured to fixedly secure the base plate to the gate via the first and second base plate mounting holes.

12. The adjustable gate latch bar of claim 10, wherein the first and second base plate mounting holes are vertically aligned when the base plate is fixedly secured to the gate.

13. The adjustable gate latch bar of claim 1, wherein the first and second elongated slots are vertically elongated when the base plate is fixedly secured to the gate.

14. The adjustable gate latch bar of claim 2, wherein each of the first and thumb screws comprises:
a) a thumb screw cup;
b) a swaged end connected to the thumb screw cup;
c) threads connected to the swaged end;
d) a shoulder connected to the threads; and
e) a head connected to the shoulder.

15. The adjustable gate latch bar of claim 14, wherein the head comprises at least one of a knurled, an upset, a textured, and a coated surface, around a perimeter of the head to facilitate gripping of the thumb screw.

16. The adjustable gate latch bar of claim 14, wherein the swaged end is configured to extend beyond a corresponding of the first and second sliding nuts to maintain connection to the corresponding sliding nut when the thumb screw is loosened.

17. The adjustable gate latch bar of claim 1, wherein the first and second elongated slots are configured to guide the first and second thumb screws to control positioning of the gate latch bar.

18. The adjustable gate latch bar of claim 1, wherein the gate latch bar is adjustable without use of tools.

19. A gate latch assembly, comprising:
a) the adjustable gate latch bar of claim 1; and
b) a gate latch having a gate latch cam configured to control latch and release of the gate latch bar.

20. The gate latch assembly of claim 19, wherein:
a) the gate latch is fixedly secured to a gate post; and
b) the adjustable gate latch bar is adjustable to be in alignment with the gate latch.
